(19) United States
(12) Patent Application Publication
(10) Pub. No.: US 2026/0333254 A1
(43) Pub. Date: Oct. 22, 2026

(54) SYNCHRONIZATION SEQUENCE FOR WIRELESS COMMUNICATION SYSTEMS

(71) Applicant: Lenovo (United States) Inc., Morrisville, NC (US)

(72) Inventors: Alexander Golitschek Edler von Elbwart, Darmstadt (DE); Prateek Basu Mallick, Dreieich (DE); Joachim Löhr, Wiesbaden (DE)

(73) Assignee: Lenovo (United States) Inc., Morrisville, NC (US)

(21) Appl. No.: 19/300,303

(22) Filed: Aug. 14, 2025

(51) Int. Cl. H04W 56/00

(52) U.S. Cl. CPC H04W 56/001

(57) ABSTRACT

Various aspects of the present disclosure relate to synchronization sequence for wireless communication systems. In implementations, a physical cell identifier (PCID) for a candidate cell and/or a radio access technology (RAT) for a candidate cell may be determined and/or indicated by an order of a synchronization sequence.

### TECHNICAL FIELD

The present disclosure relates to wireless communications, and more specifically to synchronization in wireless communications systems.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive a synchronization sequence; and compare the synchronization sequence with at least one set of candidate sequences to determine a physical cell identifier (PCID) for a candidate cell, where the PCID is determined from at least one candidate sequence out of the at least one set of candidate sequences, the at least one set of candidate sequences includes a first candidate sequence and a second candidate sequence, the first candidate sequence is configured in a reverse order of the second candidate sequence, and the PCID determined by the first candidate sequence is different than the PCID determined by the second candidate sequence.

A processor (e.g., a standalone processor chipset, or a component of a UE) for wireless communication is described. The processor may be configured to, capable of, or operable to perform one or more operations as described herein. For example, the processor may be configured to, capable of, or operable to receive a synchronization sequence; and compare the synchronization sequence with at least one set of candidate sequences to determine a PCID for a candidate cell, where the PCID is determined from at least one candidate sequence out of the at least one set of candidate sequences, the at least one set of candidate sequences includes a first candidate sequence and a second candidate sequence, the first candidate sequence is configured in a reverse order of the second candidate sequence, and the PCID determined by the first candidate sequence is different than the PCID determined by the second candidate sequence.

A method performed or performable by a UE for wireless communication is described. The method may include receiving a synchronization sequence; and comparing the synchronization sequence with at least one set of candidate sequences to determine a PCID for a candidate cell, where the PCID is determined from at least one candidate sequence out of the at least one set of candidate sequences, the at least one set of candidate sequences includes a first candidate sequence and a second candidate sequence, the first candidate sequence is configured in a reverse order of the second candidate sequence, and the PCID determined by the first candidate sequence is different than the PCID determined by the second candidate sequence.

In some implementations of the UE, the processor, and the method described herein, comparison of the synchronization sequence is based at least in part on a parameter that specifies whether the first candidate sequence or the second candidate sequence is to be used to determine or represent the PCID; the parameter specifies whether a forward sequence candidate or a reverse sequence candidate is to be used to determine or represent the PCID; the first candidate sequence is arranged in increasing order of frequency resources, and the second candidate sequence is arranged in decreasing order of frequency resources; the received synchronization sequence and the at least one set of candidate sequences include primary synchronization signal (PSS) sequences; the received synchronization sequence and the at least one set of candidate sequences include secondary synchronization signal (SSS) sequences; a cyclic shift is applied to the first candidate sequence or the second candidate sequence.

A UE for wireless communication is described. The UE may be configured to, capable of, or operable to perform one or more operations as described herein. For example, the UE may be configured to, capable of, or operable to receive a synchronization sequence; and compare the synchronization sequence with at least one set of candidate sequences to determine a radio access technology (RAT) for a candidate cell, where the at least one set of candidate sequences includes a first candidate sequence and a second candidate sequence, the first candidate sequence is configured in a reverse order of the second candidate sequence, and a first RAT represented by the first candidate sequence is different than a second RAT represented by the second candidate sequence.

A processor (e.g., a standalone processor chipset, or a component of a UE) for wireless communication is described. The processor may be configured to, capable of, or operable to perform one or more operations as described herein. For example, the processor may be configured to, capable of, or operable to receive a synchronization sequence; and compare the synchronization sequence with at least one set of candidate sequences to determine a RAT for a candidate cell, where the at least one set of candidate sequences includes a first candidate sequence and a second candidate sequence, the first candidate sequence is configured in a reverse order of the second candidate sequence, and a first RAT represented by the first candidate sequence is different than a second RAT represented by the second candidate sequence.

A method performed or performable by a UE for wireless communication is described. The method may include receiving a synchronization sequence; and comparing the synchronization sequence with at least one set of candidate sequences to determine a RAT for a candidate cell, where the at least one set of candidate sequences includes a first candidate sequence and a second candidate sequence, the first candidate sequence is configured in a reverse order of the second candidate sequence, and a first RAT represented by the first candidate sequence is different than a second RAT represented by the second candidate sequence.

In some implementations of the UE, the processor, and the method described herein, comparison of the synchronization sequence is based at least in part on a parameter that specifies whether the first candidate sequence or the second candidate sequence is to be used to determine the RAT for the candidate cell; the parameter specifies whether a forward sequence candidate or a reverse sequence candidate is to be used to determine the RAT for the candidate cell; the received synchronization sequence and the at least one set of candidate sequences include one or more of PSS sequences or SSS sequences.

An NE (e.g., a base station) for wireless communication is described. The NE may be configured to, capable of, or operable to perform one or more operations as described herein. For example, the NE may be configured to, capable of, or operable to generate a synchronization sequence from at least one set of candidate sequences to represent a PCID for a candidate cell, where the at least one set of candidate sequences includes a first candidate sequence and a second candidate sequence, the first candidate sequence is configured in a reverse order of the second candidate sequence, and the PCID corresponding to the first candidate sequence is different than the PCID corresponding to the second candidate sequence; and transmit the synchronization sequence.

A processor (e.g., a standalone processor chipset, or a component of a NE) for wireless communication is described. The processor may be configured to, capable of, or operable to perform one or more operations as described herein. For example, the processor may be configured to, capable of, or operable to generate a synchronization sequence from at least one set of candidate sequences to represent a PCID for a candidate cell, where the at least one set of candidate sequences includes a first candidate sequence and a second candidate sequence, the first candidate sequence is configured in a reverse order of the second candidate sequence, and the PCID corresponding to the first candidate sequence is different than the PCID corresponding to the second candidate sequence; and transmit the synchronization sequence.

A method performed or performable by an NE (e.g., a base station) for wireless communication is described. The method may include generating a synchronization sequence from at least one set of candidate sequences to represent a PCID for a candidate cell, where the at least one set of candidate sequences includes a first candidate sequence and a second candidate sequence, the first candidate sequence is configured in a reverse order of the second candidate sequence, and the PCID corresponding to the first candidate sequence is different than the PCID corresponding to the second candidate sequence; and transmitting the synchronization sequence.

In some implementations of the NE, the processor, and the method described herein, the synchronization sequence is generated based at least in part on a parameter that specifies whether the first candidate sequence or the second candidate sequence is to be used to determine or represents the PCID, and where the parameter is transmitted in association with the synchronization sequence; the parameter specifies whether a forward sequence candidate or a reverse sequence candidate is to be used to determine or represent the PCID; the first candidate sequence is arranged in increasing order of frequency resources, and the second candidate sequence is arranged in decreasing order of frequency resources; the synchronization sequence and the at least one set of candidate sequences include PSS sequences; the synchronization sequence and the at least one set of candidate sequences include SSS sequences.

An NE (e.g., a base station) for wireless communication is described. The NE may be configured to, capable of, or operable to perform one or more operations as described herein. For example, the NE may be configured to, capable of, or operable to generate a synchronization sequence from at least one set of candidate sequences to represent a RAT for a candidate cell, where the at least one set of candidate sequences includes a first candidate sequence and a second candidate sequence, the first candidate sequence is configured in a reverse order of the second candidate sequence, and a first RAT represented by the first candidate sequence is different than a second RAT represented by the second candidate sequence; and transmit the synchronization sequence.

A processor (e.g., a standalone processor chipset, or a component of a NE) for wireless communication is described. The processor may be configured to, capable of, or operable to perform one or more operations as described herein. For example, the processor may be configured to, capable of, or operable to generate a synchronization sequence from at least one set of candidate sequences to represent a RAT for a candidate cell, where the at least one set of candidate sequences includes a first candidate sequence and a second candidate sequence, the first candidate sequence is configured in a reverse order of the second candidate sequence, and a first RAT represented by the first candidate sequence is different than a second RAT represented by the second candidate sequence; and transmit the synchronization sequence.

A method performed or performable by an NE (e.g., a base station) for wireless communication is described. The method may include generating a synchronization sequence from at least one set of candidate sequences to represent a RAT for a candidate cell, where the at least one set of candidate sequences includes a first candidate sequence and a second candidate sequence, the first candidate sequence is configured in a reverse order of the second candidate sequence, and a first RAT represented by the first candidate sequence is different than a second RAT represented by the second candidate sequence; and transmitting the synchronization sequence.

In some implementations of the NE, the processor, and the method described herein, the synchronization sequence is generated based at least in part on a parameter that specifies whether the first candidate sequence or the second candidate sequence is to be used to determine or represent the RAT for the candidate cell; the parameter specifies whether a forward sequence candidate or a reverse sequence candidate is to be used to determine or represent the RAT for the candidate cell.

### BRIEF DESCRIPTION OF THE DRAWINGS

FIG. 1 illustrates an example of a wireless communications system in accordance with aspects of the present disclosure.

FIG. 2 illustrates an example diagram illustrating bandwidth allocation and symbol mapping.

FIG. 3 illustrates an example of a UE in accordance with aspects of the present disclosure.

FIG. 4 illustrates an example of a processor in accordance with aspects of the present disclosure.

FIG. 5 illustrates an example of an NE in accordance with aspects of the present disclosure.

FIG. 6 illustrates a flowchart of a method in accordance with aspects of the present disclosure.

FIG. 7 illustrates a flowchart of a method in accordance with aspects of the present disclosure.

FIG. 8 illustrates a flowchart of a method in accordance with aspects of the present disclosure.

FIG. 9 illustrates a flowchart of a method in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. As part of using time-frequency resources, synchronization signals represent the first signals detected by a UE in a cell search procedure. Using synchronization signals, a UE can determine a signal strength (e.g., quality of the signal), a PCID, establish time and frequency synchronization, etc. Especially for the purpose of differentiating different cells, synchronization signals can be formed by a set of sequences where the different sequences are to provide acceptable auto-correlation and cross-correlation properties. A large sequence length and a large set of different sequences may be desirable for a flexible deployment of different cells. Further, sequence generation and detection may be simplified to facilitate efficient implementations at the receiver (e.g., UE) side. Challenges pertaining to synchronization sequences include obtaining a large number of sequences (e.g., for a large number of different PCIDs) from a simple construction method, and efficient generation and/or storage of these sequences at the transmitter (e.g., NE) and receiver (e.g., UE). Further, it can be desirable to re-use existing sequence generation rules between different RATs (e.g., between 5G and 6G systems) with simple modifications to be able to differentiate a synchronization sequence from a second RAT from a synchronization sequence from a first RAT.

Aspects of the present disclosure are described in the context of a wireless communications system and include implementations that provide for an expanded number of representable wireless communication cells by using forward and reverse mapping of synchronization signal (e.g., PSS, SSS) sequences. Implementations include a cell parameter to determine or represent the PCID and whether a forward or reverse synchronization sequence is used. Implementations also include using reverse synchronization sequences for synchronization signals in a first RAT cell (e.g., a 6G cell) while using the forward sequences for a second RAT cell (e.g., for a 5G cell). For example, cells from different RATs may be differentiated using forward and reverse mapping of synchronization signal sequences. By performing the described techniques, devices in a wireless communications system can adapt to changes in RATs across networks while conserving network and device resources.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

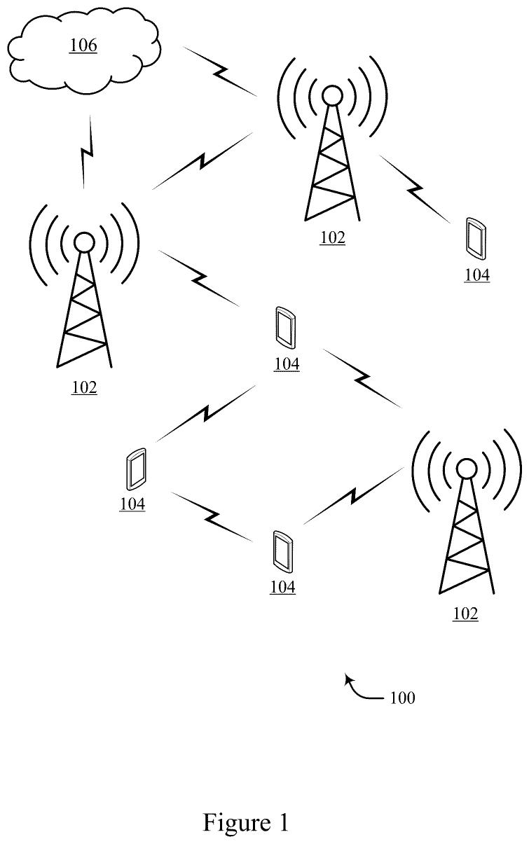

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure.

In implementations, a UE 104 receives a synchronization sequence, and compares the synchronization sequence with at least one set of candidate sequences to determine a PCID for a candidate cell, where the PCID is determined from at least one candidate sequence out of the at least one set of candidate sequences, the at least one set of candidate sequences includes a first candidate sequence and a second candidate sequence, the first candidate sequence is configured in a reverse order of the second candidate sequence, and the PCID determined by the first candidate sequence is different than the PCID determined by the second candidate sequence.

In implementations, an NE 102 (e.g., a base station) generates a synchronization sequence from at least one set of candidate sequences to represent a PCID for a candidate cell, where the at least one set of candidate sequences includes a first candidate sequence and a second candidate sequence, the first candidate sequence is configured in a reverse order of the second candidate sequence, and the PCID corresponding to the first candidate sequence is different than the PCID corresponding to the second candidate sequence; and transmits the synchronization sequence.

In implementations, a UE 104 receives a synchronization sequence; and compares the synchronization sequence with at least one set of candidate sequences to determine a RAT for a candidate cell, where the at least one set of candidate sequences includes a first candidate sequence and a second candidate sequence, the first candidate sequence is configured in a reverse order of the second candidate sequence, and a first RAT represented by the first candidate sequence is different than a second RAT represented by the second candidate sequence.

In implementations, an NE 102 (e.g., a base station) generates a synchronization sequence from at least one set of candidate sequences to represent a RAT for a candidate cell, where the at least one set of candidate sequences includes a first candidate sequence and a second candidate sequence, the first candidate sequence is configured in a reverse order of the second candidate sequence, and a first RAT represented by the first candidate sequence is different than a second RAT represented by the second candidate sequence; and transmits the synchronization sequence.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

In some wireless communications systems, the detection of PSS and SSS enables time and frequency synchronization, provides a UE with the physical layer identity of the cell and the cyclic prefix length, and informs the UE whether the cell uses Frequency Division Duplex (FDD) or Time Division Duplex (TDD). In scenarios involving initial synchronization of a UE (e.g., when the UE is not already camping on or connected to a cell) after detecting the synchronization signals, the UE may decode the physical broadcast channel (PBCH), from which system information may be obtained. In scenarios involving neighbor cell identification, the UE may determine not to decode the PBCH, and the UE may make quality-level measurements based on reference signals transmitted from a newly detected cell. The UE, for example, may use the reference signals for cell reselection (e.g., in RRC_IDLE state) or handover (e.g., in RRC_CONNECTED state). In the RRC_CONNCTED state, the UE may report the measurements to its serving cell.

For PSS and SSS, the synchronization signals may be transmitted periodically (e.g., twice per 10 ms radio frame). In an FDD cell, the PSS may be located in the last OFDM symbol of the first and 11th slots of each radio frame, thus enabling a UE to acquire the slot boundary timing independently of a CP length. The SSS may be located in the symbol immediately preceding the PSS which may enable coherent detection of the SSS relative to the PSS (e.g., considering that the channel coherence duration is significantly longer than one OFDM symbol). In a TDD cell, the PSS may be located in a 3^{rd} symbol of the 3^{rd} and 13^{th} slots, while the SSS may be located 3 symbols earlier. Coherent detection can be used based on a determination that the channel coherence time may be significantly longer than four OFDM symbols.

In implementations, the PSS in a given cell may be the same in each subframe in which it is transmitted, and two SSS transmissions in each radio frame may change in a specific manner (e.g., enabling a UE to establish the position of the 10 ms radio frame boundary). In the frequency domain, the PSS and SSS are transmitted in the central six RBs, enabling the frequency mapping of the synchronization signals to reduce variance with respect to the system bandwidth (e.g., which can vary from 6 to 110 RBs to accommodate channel bandwidths between 1.4 MHz and 20 MHz). Such implementations can enable a UE to synchronize to the network without a priori knowledge of the allocated bandwidth. The PSS and SSS can each include a sequence of length 62 symbols, mapped to the central 62 subcarriers around the DC subcarrier, which may be left unused. For example, five resource elements at each extremity of each synchronization sequence may not be used. This structure ay enable the UE to detect the PSS and SSS using a size-64 Fast Fourier Transform (FFT) and a lower sampling rate than may be used if 72 subcarriers were used in a central six RBs. A shorter length for the synchronization sequences may mitigate the possibility in a TDD system of a high correlation with the uplink demodulation reference signals which use the same kind of sequence as the PSS. In some scenarios, the particular sequences which are transmitted for the PSS and SSS in a given cell may be used to indicate the PCID to the UE. In some wireless communications systems there are 504 unique PCIDs grouped into 168 groups of three identities. The three identities in a group may be assigned to cells under the control of a same NE. Three PSS sequences may be used to indicate the cell identity within the group, and 168 SSS sequences may be used to indicate the identity of the group.

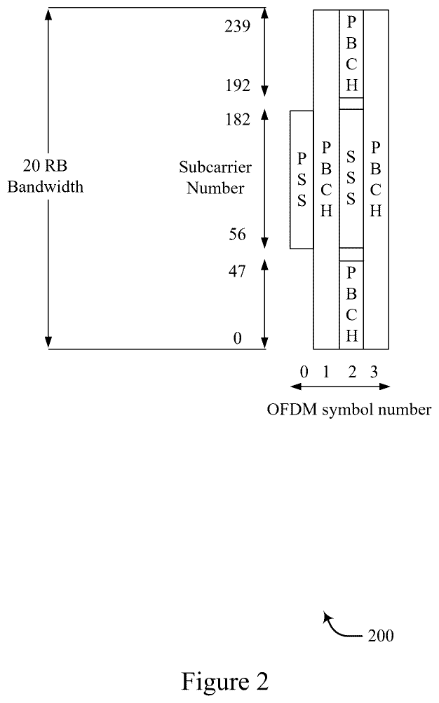

FIG. 2 illustrates an example diagram 200 illustrating bandwidth allocation and symbol mapping. The PSS and SSS are transmitted in SSBs together with PBCH and the blocks are transmitted per slot at a fixed slot location. During an initial cell search, a UE may correlate the received signals and the synchronization signal sequences via matched filtering and attempt to locate the PSS to obtain symbol and half-frame timing. The UE may attempt to find the SSS to detect the cyclic prefix length and the duplexing scheme and to obtain the exact frame timing based on matched filter results for the PSS and SSS. The UE may detect the cell identity from the reference signals sequence index to decode the PBCH to obtain a minimum SI.

NR includes 1008 unique physical-layer cell identities including 336 unique physical-layer cell-identity groups, with each group containing three unique identities. Each NR cell ID can be jointly represented by a PSS/SSS combination. Each PSS may include three frequency-domain binary BPSK length-127 M-sequences, and the SSS corresponds to 336 Gold sequences with length-127. The PSS and SSS signals may be mapped into 127 contiguous subcarriers. A physical-layer cell identity may be defined by a number in the range of 0-1007 based on the formula

$${N}_{ID}^{cell} = 3 {N}_{ID}^{( 1 )} + {N}_{ID}^{( 2 )} where {N}_{ID}^{( 1 )} ∈ \{ 0 , 1 , … , 335 \} and {N}_{ID}^{( 2 )} ∈ \{ 0 , 1 , 2 \} ,$$

For PSS sequence generation and mapping to resources, the sequence d_{PSS}(n) for the primary synchronization signal may be defined by:

$${d}_{PSS} ( n ) = 1 - 2 x ( m )$$

$$m = ( n + 43 {N}_{ID}^{( 2 )} ) mod 127$$

$$0 \leq n < 127$$

where

x(i+7)=(x(i+4)+x(i)mod 2

and

[x(6)x(5)x(4)x(3)x(2)x(1)x(0)]=[1 1 1 0 1 1 0]

A UE may assume the sequence of symbols d_{PSS}(0), . . . , d_{PSS}(126) constituting the primary synchronization signal to be scaled by a factor β_{PSS} to conform to a PSS power allocation and mapped to resource elements (k, l)_{p,μ} in increasing order of k where k and l are given by Table 7.4.3.1-1 and represent the frequency and time indices, respectively, within one SS/PBCH block. (See 3GPP TS 38.211).

For SSS sequence generation and mapping to resources, the sequence d_{SSS}(n) for the secondary synchronization signal may be defined by:

$${d}_{SSS} ( n ) = [ 1 - 2 {x}_{0} ( ( n + {m}_{0} ) mod 127 ) ] [ 1 - 2 {x}_{1} ( ( n + {m}_{1} ) mod 127 ) ]$$

$${m}_{0} = 15 ⌊ \frac{{N}_{ID}^{( 1 )}}{112} ⌋ + 5 {N}_{ID}^{( 2 )}$$

$${m}_{1} = {N}_{ID}^{( 1 )} mod 112$$

$$0 \leq n < 127$$

where

x₀(i+7)=(x₀(i+4)+x₀(i))mod 2

x₁(i+7)=(x₁(i+1)+x₁(i)mod 2

and

[x₀(6)x₀(5)x₀(4)x₀(3)x₀(2)x₀(1)x₀(0)]=[0 0 0 0 0 0 1]

[x₁(6)x₁(5)x₁(4)x₁(3)x₁(2)x₁(1)x₁(0)]=[0 0 0 0 0 0 1]

A UE may assume the sequence of symbols d_{SSS}(0), . . . , d_{SSS}(126) constituting the secondary synchronization signal to be scaled by a factor β_{SSS} and mapped to resource elements (k, l)_{p,μ} in increasing order of k where k and l are given by Table 7.4.3.1-1 and represent the frequency and time indices, respectively, within one SS/PBCH block. (See 3GPP TS 38.211).

For time-frequency structure of an SS/PBCH block, in the time domain an SS/PBCH block may include 4 OFDM symbols, numbered in increasing order from 0 to 3 within the SS/PBCH block, where PSS, SSS, and PBCH with associated DM-RS are mapped to symbols as given by Table 7.4.3.1-1. In the frequency domain, an SS/PBCH block includes 240 contiguous subcarriers with the subcarriers numbered in increasing order from 0 to 239 within the SS/PBCH block. The quantities k and l represent the frequency and time indices, respectively, within one SS/PBCH block. The UE may assume that the complex-valued symbols corresponding to resource elements denoted as ‘Set to 0’ in Table 7.4.3.1-1 are set to zero. The quantity v in Table 7.4.3.1-1 is given by

$$v = {N}_{ID}^{cell}$$

mod 4. Ine quantity k_{SSB} is the subcarrier offset from subcarrier 0 in common resource block

$${N}_{CRB}^{SSB}$$

to the lowest-numbered subcarrier of the SS/PBCH block, or the SS/PBCH block after puncturing if applicable, where

$${N}_{CRB}^{SSB}$$

is obtained from the nigher-layer parameter offsetToPointA.

TABLE 7.4.3.1-1
Resources within an SS/PBCH block for PSS, SSS, PBCH, and
DM-RS for PBCH.

| Channel | OFDM symbol number/ | Subcarrier number k |
|---|---|---|
| or | relative to the start of an | relative to the start of |
| signal | SS/PBCH block | an SS/PBCH block |
| PSS | 0 | 56, 57, . . . , 182 |
| SSS | 2 | 56, 57, . . . , 182 |
| Set to 0 | 0 | 0, 1, . . . , 55, 183, |
| | | 184, . . . , 239 |
| | 2 | 48, 49, . . . , 55, 183, |
| | | 184, . . . , 191 |
| PBCH | 1, 3 | 0, 1, . . . , 239 |
| | 2 | 0, 1, . . . , 47, |
| | | 192, 193, . . . , 239 |
| DM-RS | 1, 3 | 0 + v, 4 + v, 8 + v, . . . , |
| for | | 236 + v |
| PBCH | 2 | 0 + v, 4 + v, 8 + v, . . . , |
| | | 44 + v |
| | | 192 + v, 196 + v, . . . , |
| | | 236 + v |

Aspects of the present disclosure include solutions for synchronization sequences in wireless communications systems. In implementations, synchronization signal sequences use at least a forward (e.g., normal) and reverse mapping to time/frequency resources. Inversion of order in time domain may result in inversion of order in frequency domain (e.g., Fourier transform property), which may enable simple implementations for sequence generation/storage. Using the same sequence in forward and reverse mapping may also enable doubling of potential sequences. For example, for m-Sequences and Gold sequences (used for 5G PSS and SSS, respectively), the cross-correlation of forward/reverse sequences may be comparable to that of two different forward or reverse sequences.

In implementations, a PCID (e.g., extended PCID) may be determined by:

$${N}_{ID}^{cell} = 1008 {N}_{ID}^{( 0 )} + 3 {N}_{ID}^{( 1 )} + {N}_{ID}^{( 2 )}$$

For example with

$${N}_{ID}^{( 1 )} ∈ \{ 0 , 1 , … , 355 \} , {N}_{ID}^{( 2 )} ∈ \{ 0 , 1 , 2 \} and {N}_{ID}^{( 0 )} ∈ \{ 0 , 1 \}$$

this results in 2016 distinct PCIDs, e.g., 2× number of PCIDs in 5G.

PSS (e.g., for 6G) may use a sequence generation (e.g., based on

$${N}_{ID}^{( 2 )} ) ,$$

and the mapping to resources may be mapped to resource elements (k, l)_{p,μ} in increasing order of k and mapped to resource elements (k, l)_{p,μ} in decreasing order of k. SSS may use sequence generation (e.g., based on

$${N}_{ID}^{( 1 )} and {N}_{ID}^{( 2 )} ) ,$$

and the mapping to resources may be for

$${N}_{ID}^{( 0 )} = 0 :$$

mapped to resource elements (k, l)_{p,μ} in increasing order of k (e.g., assuming above extended PCID formula) and for

$${N}_{ID}^{( 0 )} = 1 :$$

mapped to resource elements (k, l)_{p,μ} in decreasing order of k. Optionally, a cyclic shift may be applied to a flipped/reversed sequence.

In implementations, a first sequence for a synchronization signal and a second sequence for a synchronization signal may be specified based on that the first sequence can be expressed as the reverse of the second sequence (e.g., by changing the order of elements that make up the sequence). For example, the first sequence can be obtained by reversing the second sequence, and vice versa. In implementations, the first sequence and the second sequence may be used for transmission as a synchronization signal in a wireless communication system. Each sequence may include a primary or a secondary synchronization signal (PSS or SSS, respectively).

In implementations, a receiver (e.g., UE 104) may receive a cell identifier such as a PCID from one or more cell parameters, where a synchronization sequence may be based on at least one cell parameter. For example, a first cell parameter

$${N}_{ID}^{( 0 )}$$

may indicate whether a sequence is obtained or transmitted in a forward or reverse order. A PCID may be based on the first cell parameter. For example, for

$${N}_{ID}^{( 0 )} ∈ \{ 0 , 1 \} ,$$

a value of

$${N}_{ID}^{( 0 )} = 0$$

results in a PCID value between 0 and 1007, while a value of

$${N}_{ID}^{( 0 )} = 1$$

results in a row value between 1008 and 2015. Which of these values is utilized may be based on a second and third cell parameter

$$( {N}_{ID}^{( 1 )} and {N}_{ID}^{( 2 )} ,$$

respectively). For example, the PCID value may be determined by

$${N}_{ID}^{cell} = 1008 {N}_{ID}^{( 0 )} + 3 {N}_{ID}^{( 1 )} + {N}_{ID}^{( 2 )} , with$$

$${N}_{ID}^{( 0 )} ∈ \{ 0 , 1 \} , {N}_{ID}^{( 1 )} ∈ \{ 0 , 1 , … , 335 \} , {N}_{ID}^{( 2 )} ∈ \{ 0 , 1 , 2 \} .$$

In implementations, a PSS sequence may be obtained by (with

$${N}_{ID}^{( 0 )} ∈ \{ 0 , 1 \} , {N}_{ID}^{( 1 )} ∈ \{ 0 , 1 , … , 335 \} , {N}_{ID}^{( 2 )} ∈ \{ 0 , 1 , 2 \} ) \\ {d}_{PSS} ( n ) = 1 - 2 x ( m ) \\ m = ( ( 1 - 2 {N}_{ID}^{( 0 )} ) n + 43 {N}_{ID}^{( 2 )} ) mod 127 \\ 0 \leq n < 127$$

In implementations, a SSS sequence may be obtained by (with

$${N}_{ID}^{( 0 )} ∈ \{ 0 , 1 \} , {N}_{ID}^{( 1 )} ∈ \{ 0 , 1 , … , 335 \} , {N}_{ID}^{( 2 )} ∈ \{ 0 , 1 , 2 \} )$$

$${d}_{SSS} ( n ) = [ \text{} 1 - 2 {x}_{0} ( ( ( 1 - 2 {N}_{ID}^{( 0 )} ) n + {m}_{0} ) mod 127 ) ] [ \text{} 1 - 2 {x}_{1} ( ( ( 1 - 2 {N}_{ID}^{( 0 )} ) n + {m}_{1} ) mod 127 ) ]$$

$${m}_{0} = 15 ⌊ \frac{{N}_{ID}^{( 1 )}}{112} ⌋ + 5 {N}_{ID}^{( 2 )} \\ {m}_{1} = {N}_{ID}^{( 1 )} mod 112 \\ 0 \leq n < 127$$

In implementations, a first synchronization sequence may be mapped to resource elements in increasing order of k for a first value of the first cell parameter, and mapped to resource elements in decreasing order of k for a second value of the first cell parameter. In implementations, for a first value of the first cell parameter, a synchronization sequence can be generated by a first polynomial, and for a second value of the first cell parameter a synchronization sequence can be generated by a second polynomial, where the second polynomial is the reverse of the first polynomial. For example, assuming that a first (e.g., forward) polynomial representing the linear feedback shift register (LFSR) representation of a PSS sequence generator can be expressed as a first polynomial Λ(x)=x⁷+x⁴+1, a second (e.g., reverse) polynomial representing the linear feedback shift register (LFSR) representation of a PSS sequence generator can be expressed as Λ̅(x)=x⁷+x³+1. The sequence obtained by such a reverse polynomial representation may be mapped in the same order as that of the forward polynomial representation (e.g., in increasing order of k). Alternatively, or in addition, the initialization of the reverse polynomial LFSR may be different from the initialization of the forward polynomial LFSR.

In implementations, a synchronization signal for a first RAT (e.g., 6G) may be mapped to physical resources in the opposite order in one or more of time/frequency domain compared to a synchronization signal for a second RAT (e.g., 5G). In implementations, a PSS for the first RAT may follow a same sequence generation rule as a second RAT, but may employ an opposite mapping order of sequence elements to resource elements compared to the second RAT. For example, in the second RAT the UE may assume the sequence of symbols d_{PSS}(0), . . . , d_{PSS}(126) including the primary synchronization signal to be mapped to resource elements (k, l)_{p,μ} in increasing order of k where k and l are given by Table 7.4.3.1-1 and representing the frequency and time indices, respectively, within one SS/PBCH block. In the first RAT the UE may assume the sequence of symbols d_{PSS}(0), . . . , d_{PSS}(126) constituting the primary synchronization signal to be mapped to resource elements (k, l)_{p,μ} in decreasing order of k where k and l are given by Table 7.4.3.1-1 and represent the frequency and time indices, respectively, within one SS/PBCH block.

In implementations, a UE can determine whether a SS/PBCH block constitutes a second RAT cell by determining a higher likelihood that the received sequence originated from a second RAT PSS sequence mapped to resource elements in increasing order of k than that the received sequence originated from a second RAT PSS sequence mapped to resource elements in decreasing order of k. A UE can determine whether a SS/PBCH block constitutes a first RAT cell by determining a higher likelihood that the received sequence originated from a second RAT PSS sequence mapped to resource elements in decreasing order of k than that the received sequence originated from a second RAT PSS sequence mapped to resource elements in increasing order of k. In implementations, such determinations may be made without further consideration of a received SSS sequence.

In implementations, an SSS of a first RAT follows the sequence generation rule as in a second RAT, but may employ an opposite mapping order of sequence elements to resource elements compared to the second RAT. For example, in the second RAT (e.g., 5G), the UE may assume the sequence of symbols d_{SSS}(0), . . . , d_{SSS}(126) including the secondary synchronization signal to be mapped to resource elements (k, l)_{p,μ} in increasing order of k where k and l may be given by Table 7.4.3.1-1 and represent the frequency and time indices, respectively, within one SS/PBCH block. In the first RAT, the UE may assume the sequence of symbols d_{SSS}(0), . . . , d_{SSS}(126) including the secondary synchronization signal to be mapped to resource elements (k, l)_{p,μ} in decreasing order of k where k and/may be given by Table 7.4.3.1-1 and represent the frequency and time indices, respectively, within one SS/PBCH block.

In implementations, where the PSS used for the first RAT is the same as used for the second RAT (e.g., the PSS is mapped to resource elements in increasing order of k), in such implementations a UE can determine whether a SS/PBCH block constitutes a cell of the second RAT by determining a higher likelihood that the received sequence originated from a second RAT SSS sequence mapped to resource elements in increasing order of k than that the received sequence originated from a second RAT SSS sequence mapped to resource elements in decreasing order of k. In implementations, a UE can determine whether a SS/PBCH block constitutes a cell of the first RAT by determining a higher likelihood that the received sequence originated from a first RAT SSS sequence mapped to resource elements in decreasing order of k than that the received sequence originated from a first RAT SSS sequence mapped to resource elements in increasing order of k.

In implementations, a PSS or SSS of the first RAT may be generated by using the reverse polynomial of a second RAT sequence. For example, assuming that the (e.g., forward) polynomial representing the LFSR representation of a second RAT PSS sequence generator can be expressed as Λ(x)=x⁷+x⁴+1, then the reverse polynomial representing the LFSR representation of a first RAT PSS sequence generator can be expressed as Λ̅(x)=x⁷+x³+1. The sequence obtained by such a reverse polynomial representation may then be mapped in the same order as that of the forward polynomial representation (e.g., in increasing order of k). Optionally the initialization of the reverse polynomial LFSR is different from the initialization of the forward polynomial LFSR.

In implementations, the forward/reverse mapping of a generated sequence (e.g., PSS, SSS) may be applied to a sequence used for reference signals. For example, a sequence may be used for demodulation reference signals (DM-RS) along/inside a PBCH or SS/PBCH block transmission. Accordingly, the mapping rule applied to DM-RS can be specified as follows:

In one implementation, a UE may assume the sequence of complex-valued symbols r(0), . . . , r(143) constituting the demodulation reference signals for the SS/PBCH block to be scaled by a factor of

$${β}_{PBCH}^{DM - RS}$$

to conform to the PBCH power allocation and to be mapped to resource elements (k, l)_{p,μ} in increasing order of first k and then l where k and l are given by Table 7.4.3.1-1 and represent the frequency and time indices, respectively, within one SS/PBCH block.

In one implementation, the UE may assume the sequence of complex-valued symbols r(0), . . . , r(143) constituting the demodulation reference signals for the SS/PBCH block to be scaled by a factor of

$${β}_{PBCH}^{DM - RS}$$

to conform to the PBCH power allocation and to be mapped to resource elements (k, l)_{p,μ} in decreasing order of first k and then increasing/decreasing order of l where k and l are given by Table 7.4.3.1-1 and represent the frequency and time indices, respectively, within one SS/PBCH block.

In implementations, where in the second RAT a synchronization sequence is mapped to resource elements (k, l)_{p,μ} in increasing order of first k and then l, for the first RAT a synchronization sequence may be mapped to resource elements (k, l)_{p,μ} in decreasing order of first k and then l. In implementations, a mapping order may be determined by a parameter. Such a parameter may be configured or determined, e.g., by a value of cell parameter

$${N}_{ID}^{( 0 )} .$$

In implementations, a first cell parameter

$${N}_{ID}^{( 0 )}$$

indicates whether a sequence is obtained or transmitted in a forward (increasing) or reverse (decreasing) order.

In implementations, the synchronization sequences may be cyclically shifted before or when applying the mapping to time/frequency resources. For example, the sequences for a PSS can apply a cyclical shift by [c1, c2, c3] instead of [0, 43, 86] to represent cell ID information

$${N}_{ID}^{( 2 )} = [ 0 , 1 , 2 ] ,$$

correspondingly. Example shifts that show good cross-correlation properties for a sequence applying reverse mapping when compared with non-shifted (e.g., using [0, 43, 86]) PSS using forward mapping are [21, 64, 107], [22, 65, 108], [23, 66, 109], [62, 105, 21], [64, 107, 23], [105, 21, 64], [106, 22, 65], [107, 23, 66], [13, 56, 99], [28, 71, 114], [56, 99, 15], [12, 55, 98].

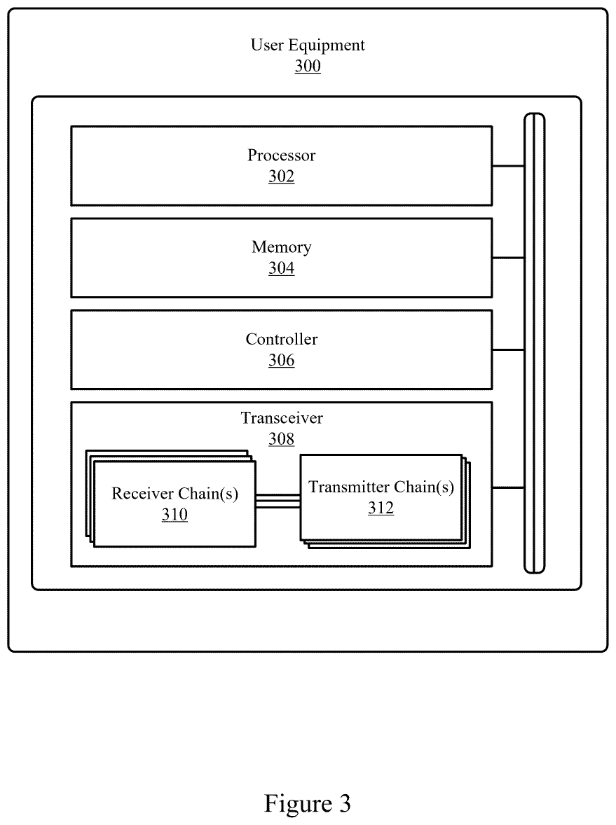

FIG. 3 illustrates an example of a UE 300 in accordance with aspects of the present disclosure. The UE 300 may include a processor 302, a memory 304, a controller 306, and a transceiver 308. The processor 302, the memory 304, the controller 306, or the transceiver 308, or various combinations thereof or various components thereof may be examples of means for performing various aspects of the present disclosure as described herein. These components may be coupled (e.g., operatively, communicatively, functionally, electronically, electrically) via one or more interfaces.

The processor 302, the memory 304, the controller 306, or the transceiver 308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 302 may include an intelligent hardware device (e.g., a general-purpose processor, a DSP, a CPU, an ASIC, an FPGA, or any combination thereof). In some implementations, the processor 302 may be configured to operate the memory 304. In some other implementations, the memory 304 may be integrated into the processor 302. The processor 302 may be configured to execute computer-readable instructions stored in the memory 304 to cause the UE 300 to perform various functions of the present disclosure.

The memory 304 may include volatile or non-volatile memory. The memory 304 may store computer-readable, computer-executable code including instructions when executed by the processor 302 cause the UE 300 to perform various functions described herein. The code may be stored in a non-transitory computer-readable medium such as the memory 304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 302 and the memory 304 coupled with the processor 302 may be configured to cause the UE 300 to perform one or more of the functions described herein (e.g., executing, by the processor 302, instructions stored in the memory 304). For example, the processor 302 may support wireless communication at the UE 300 in accordance with examples as disclosed herein.

The UE 300 may be configured to or operable to support a means for receiving a synchronization sequence; and comparing the synchronization sequence with at least one set of candidate sequences to determine a PCID for a candidate cell, where the PCID is determined from at least one candidate sequence out of the at least one set of candidate sequences, the at least one set of candidate sequences includes a first candidate sequence and a second candidate sequence, the first candidate sequence is configured in a reverse order of the second candidate sequence, and the PCID determined by the first candidate sequence is different than the PCID determined by the second candidate sequence.

Additionally, the UE 300 may be configured to support any one or combination of where comparison of the synchronization sequence is based at least in part on a parameter that specifies whether the first candidate sequence or the second candidate sequence is to be used to determine or represent the PCID; the parameter specifies whether a forward sequence candidate or a reverse sequence candidate is to be used to determine or represent the PCID; the first candidate sequence is arranged in increasing order of frequency resources, and the second candidate sequence is arranged in decreasing order of frequency resources; the received synchronization sequence and the at least one set of candidate sequences include PSS sequences; the received synchronization sequence and the at least one set of candidate sequences include SSS sequences; a cyclic shift is applied to the first candidate sequence or the second candidate sequence.

Additionally, or alternatively, the UE 300 may support at least one memory (e.g., the memory 304) and at least one processor (e.g., the processor 302) coupled with the at least one memory and configured to cause the UE to receive a synchronization sequence; and compare the synchronization sequence with at least one set of candidate sequences to determine a PCID for a candidate cell, where the PCID is determined from at least one candidate sequence out of the at least one set of candidate sequences, the at least one set of candidate sequences includes a first candidate sequence and a second candidate sequence, the first candidate sequence is configured in a reverse order of the second candidate sequence, and the PCID determined by the first candidate sequence is different than the PCID determined by the second candidate sequence.

Additionally, the UE 300 may be configured to support any one or combination of where comparison of the synchronization sequence is based at least in part on a parameter that specifies whether the first candidate sequence or the second candidate sequence is to be used to determine or represent the PCID; the parameter specifies whether a forward sequence candidate or a reverse sequence candidate is to be used to determine or represent the PCID; the first candidate sequence is arranged in increasing order of frequency resources, and the second candidate sequence is arranged in decreasing order of frequency resources; the received synchronization sequence and the at least one set of candidate sequences include PSS sequences; the received synchronization sequence and the at least one set of candidate sequences include SSS sequences; a cyclic shift is applied to the first candidate sequence or the second candidate sequence.

The UE 300 may be configured to or operable to support a means for receiving a synchronization sequence; and comparing the synchronization sequence with at least one set of candidate sequences to determine a RAT for a candidate cell, where the at least one set of candidate sequences includes a first candidate sequence and a second candidate sequence, the first candidate sequence is configured in a reverse order of the second candidate sequence, and a first RAT represented by the first candidate sequence is different than a second RAT represented by the second candidate sequence.

Additionally, the UE 300 may be configured to support any one or combination of where comparison of the synchronization sequence is based at least in part on a parameter that specifies whether the first candidate sequence or the second candidate sequence is to be used to determine the RAT for the candidate cell; the parameter specifies whether a forward sequence candidate or a reverse sequence candidate is to be used to determine the RAT for the candidate cell; the received synchronization sequence and the at least one set of candidate sequences include one or more of PSS sequences or SSS sequences.

Additionally, or alternatively, the UE 300 may support at least one memory (e.g., the memory 304) and at least one processor (e.g., the processor 302) coupled with the at least one memory and configured to cause the UE to receive a synchronization sequence; and compare the synchronization sequence with at least one set of candidate sequences to determine a RAT for a candidate cell, where the at least one set of candidate sequences includes a first candidate sequence and a second candidate sequence, the first candidate sequence is configured in a reverse order of the second candidate sequence, and a first RAT represented by the first candidate sequence is different than a second RAT represented by the second candidate sequence.

Additionally, the UE 300 may be configured to support any one or combination of where comparison of the synchronization sequence is based at least in part on a parameter that specifies whether the first candidate sequence or the second candidate sequence is to be used to determine the RAT for the candidate cell; the parameter specifies whether a forward sequence candidate or a reverse sequence candidate is to be used to determine the RAT for the candidate cell; the received synchronization sequence and the at least one set of candidate sequences include one or more of PSS sequences or SSS sequences.

The controller 306 may manage input and output signals for the UE 300. The controller 306 may also manage peripherals not integrated into the UE 300. In some implementations, the controller 306 may utilize an operating system such as iOS®, ANDROID®, WINDOWS®, or other operating systems. In some implementations, the controller 306 may be implemented as part of the processor 302.

In some implementations, the UE 300 may include at least one transceiver 308. In some other implementations, the UE 300 may have more than one transceiver 308. The transceiver 308 may represent a wireless transceiver. The transceiver 308 may include one or more receiver chains 310, one or more transmitter chains 312, or a combination thereof.

A receiver chain 310 may be configured to receive signals (e.g., control information, data, packets) over a wireless medium. For example, the receiver chain 310 may include one or more antennas to receive a signal over the air or wireless medium. The receiver chain 310 may include at least one amplifier (e.g., a low-noise amplifier (LNA)) configured to amplify the received signal. The receiver chain 310 may include at least one demodulator configured to demodulate the receive signal and obtain the transmitted data by reversing the modulation technique applied during transmission of the signal. The receiver chain 310 may include at least one decoder for decoding the demodulated signal to receive the transmitted data.

A transmitter chain 312 may be configured to generate and transmit signals (e.g., control information, data, packets). The transmitter chain 312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 312 may also include at least one power amplifier configured to amplify the modulated signal to an appropriate power level suitable for transmission over the wireless medium. The transmitter chain 312 may also include one or more antennas for transmitting the amplified signal into the air or wireless medium.

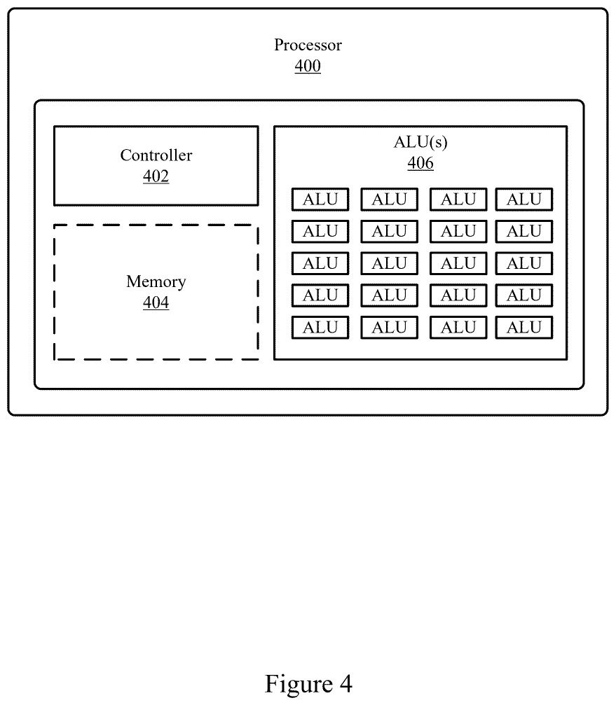

FIG. 4 illustrates an example of a processor 400 in accordance with aspects of the present disclosure. The processor 400 may be an example of a processor configured to perform various operations in accordance with examples as described herein. The processor 400 may include a controller 402 configured to perform various operations in accordance with examples as described herein. The processor 400 may optionally include at least one memory 404, which may be, for example, an L1/L2/L3 cache. Additionally, or alternatively, the processor 400 may optionally include one or more arithmetic-logic units (ALUs) 406. One or more of these components may be in electronic communication or otherwise coupled (e.g., operatively, communicatively, functionally, electronically, electrically) via one or more interfaces (e.g., buses).

The processor 400 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 400) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 402 may be configured to manage and coordinate various operations (e.g., signaling, receiving, obtaining, retrieving, transmitting, outputting, forwarding, storing, determining, identifying, accessing, writing, reading) of the processor 400 to cause the processor 400 to support various operations in accordance with examples as described herein. For example, the controller 402 may operate as a control unit of the processor 400, generating control signals that manage the operation of various components of the processor 400. These control signals include enabling or disabling functional units, selecting data paths, initiating memory access, and coordinating timing of operations.

The controller 402 may be configured to fetch (e.g., obtain, retrieve, receive) instructions from the memory 404 and determine subsequent instruction(s) to be executed to cause the processor 400 to support various operations in accordance with examples as described herein. The controller 402 may be configured to track memory addresses of instructions associated with the memory 404. The controller 402 may be configured to decode instructions to determine the operation to be performed and the operands involved. For example, the controller 402 may be configured to interpret the instruction and determine control signals to be output to other components of the processor 400 to cause the processor 400 to support various operations in accordance with examples as described herein. Additionally, or alternatively, the controller 402 may be configured to manage flow of data within the processor 400. The controller 402 may be configured to control transfer of data between registers, ALUs 406, and other functional units of the processor 400.

The memory 404 may include one or more caches (e.g., memory local to or included in the processor 400 or other memory, such as RAM, ROM, DRAM, SDRAM, SRAM, MRAM, flash memory, etc. In some implementations, the memory 404 may reside within or on a processor chipset (e.g., local to the processor 400). In some other implementations, the memory 404 may reside external to the processor chipset (e.g., remote to the processor 400).

The memory 404 may store computer-readable, computer-executable code including instructions that, when executed by the processor 400, cause the processor 400 to perform various functions described herein. The code may be stored in a non-transitory computer-readable medium such as system memory or another type of memory. The controller 402 and/or the processor 400 may be configured to execute computer-readable instructions stored in the memory 404 to cause the processor 400 to perform various functions. For example, the processor 400 and/or the controller 402 may be coupled with or to the memory 404, the processor 400, and the controller 402, and may be configured to perform various functions described herein. In some examples, the processor 400 may include multiple processors and the memory 404 may include multiple memories. One or more of the multiple processors may be coupled with one or more of the multiple memories, which may, individually or collectively, be configured to perform various functions herein.

The one or more ALUs 406 may be configured to support various operations in accordance with examples as described herein. In some implementations, the one or more ALUs 406 may reside within or on a processor chipset (e.g., the processor 400). In some other implementations, the one or more ALUs 406 may reside external to the processor chipset (e.g., the processor 400). One or more ALUs 406 may perform one or more computations such as addition, subtraction, multiplication, and division on data. For example, one or more ALUs 406 may receive input operands and an operation code, which determines an operation to be executed. One or more ALUs 406 may be configured with a variety of logical and arithmetic circuits, including adders, subtractors, shifters, and logic gates, to process and manipulate the data according to the operation. Additionally, or alternatively, the one or more ALUs 406 may support logical operations such as AND, OR, exclusive-OR (XOR), not-OR (NOR), and not-AND (NAND), enabling the one or more ALUs 406 to handle conditional operations, comparisons, and bitwise operations.

The processor 400 may support wireless communication in accordance with examples as disclosed herein. The processor 400 may be configured to or operable to support at least one controller (e.g., the controller 402) coupled with at least one memory (e.g., the memory 404) and configured to cause the processor to receive a synchronization sequence; and compare the synchronization sequence with at least one set of candidate sequences to determine a PCID for a candidate cell, where the PCID is determined from at least one candidate sequence out of the at least one set of candidate sequences, the at least one set of candidate sequences includes a first candidate sequence and a second candidate sequence, the first candidate sequence is configured in a reverse order of the second candidate sequence, and the PCID determined by the first candidate sequence is different than the PCID determined by the second candidate sequence.

Additionally, the processor 400 may be configured to or operable to support any one or combination of where comparison of the synchronization sequence is based at least in part on a parameter that specifies whether the first candidate sequence or the second candidate sequence is to be used to determine or represent the PCID; the parameter specifies whether a forward sequence candidate or a reverse sequence candidate is to be used to determine or represent the PCID; the first candidate sequence is arranged in increasing order of frequency resources, and the second candidate sequence is arranged in decreasing order of frequency resources; the received synchronization sequence and the at least one set of candidate sequences include PSS sequences; the received synchronization sequence and the at least one set of candidate sequences include SSS sequences; a cyclic shift is applied to the first candidate sequence or the second candidate sequence.

The processor 400 may support wireless communication in accordance with examples as disclosed herein. The processor 400 may be configured to or operable to support at least one controller (e.g., the controller 402) coupled with at least one memory (e.g., the memory 404) and configured to cause the processor to receive a synchronization sequence; and compare the synchronization sequence with at least one set of candidate sequences to determine a RAT for a candidate cell, where the at least one set of candidate sequences includes a first candidate sequence and a second candidate sequence, the first candidate sequence is configured in a reverse order of the second candidate sequence, and a first RAT represented by the first candidate sequence is different than a second RAT represented by the second candidate sequence.

Additionally, the processor 400 may be configured to or operable to support any one or combination of where comparison of the synchronization sequence is based at least in part on a parameter that specifies whether the first candidate sequence or the second candidate sequence is to be used to determine the RAT for the candidate cell; the parameter specifies whether a forward sequence candidate or a reverse sequence candidate is to be used to determine the RAT for the candidate cell; the received synchronization sequence and the at least one set of candidate sequences include one or more of PSS sequences or SSS sequences.

The processor 400 may support wireless communication in accordance with examples as disclosed herein. The processor 400 may be configured to or operable to support at least one controller (e.g., the controller 402) coupled with at least one memory (e.g., the memory 404) and configured to cause the processor to generate a synchronization sequence from at least one set of candidate sequences to represent a PCID for a candidate cell, where the at least one set of candidate sequences includes a first candidate sequence and a second candidate sequence, the first candidate sequence is configured in a reverse order of the second candidate sequence, and the PCID corresponding to the first candidate sequence is different than the PCID corresponding to the second candidate sequence; and transmit the synchronization sequence.

Additionally, the processor 400 may be configured to or operable to support any one or combination of where the synchronization sequence is generated based at least in part on a parameter that specifies whether the first candidate sequence or the second candidate sequence is to be used to determine or represent the PCID, and where the parameter is transmitted in association with the synchronization sequence; the parameter specifies whether a forward sequence candidate or a reverse sequence candidate is to be used to determine or represent the PCID; the first candidate sequence is arranged in increasing order of frequency resources, and the second candidate sequence is arranged in decreasing order of frequency resources; the synchronization sequence and the at least one set of candidate sequences include PSS sequences; the synchronization sequence and the at least one set of candidate sequences include SSS sequences.

The processor 400 may support wireless communication in accordance with examples as disclosed herein. The processor 400 may be configured to or operable to support at least one controller (e.g., the controller 402) coupled with at least one memory (e.g., the memory 404) and configured to cause the processor to generate a synchronization sequence from at least one set of candidate sequences to represent a RAT for a candidate cell, where the at least one set of candidate sequences includes a first candidate sequence and a second candidate sequence, the first candidate sequence is configured in a reverse order of the second candidate sequence, and a first RAT represented by the first candidate sequence is different than a second RAT represented by the second candidate sequence; and transmit the synchronization sequence.

Additionally, the processor 400 may be configured to or operable to support any one or combination of where the synchronization sequence is generated based at least in part on a parameter that specifies whether the first candidate sequence or the second candidate sequence is to be used to determine the RAT for the candidate cell; the parameter specifies whether a forward sequence candidate or a reverse sequence candidate is to be used to determine the RAT for the candidate cell.

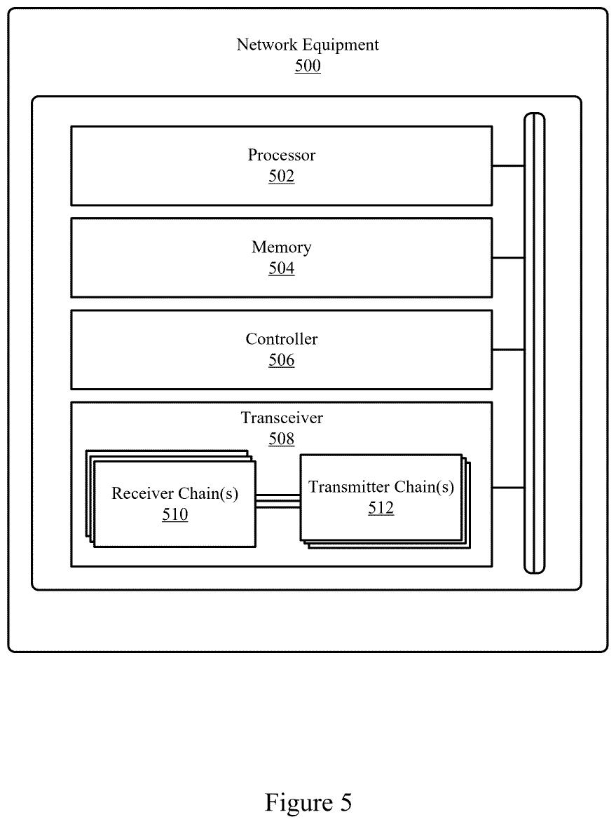

FIG. 5 illustrates an example of an NE 500 in accordance with aspects of the present disclosure. The NE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the NE 500 to perform various functions of the present disclosure.

The memory 504 may include volatile or non-volatile memory. The memory 504 may store computer-readable, computer-executable code including instructions when executed by the processor 502 cause the NE 500 to perform various functions described herein. The code may be stored in a non-transitory computer-readable medium such as the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the NE 500 to perform one or more of the functions described herein (e.g., executing, by the processor 502, instructions stored in the memory 504).

For example, the processor 502 may support wireless communication at the NE 500 in accordance with examples as disclosed herein. The NE 500 may be configured to or operable to support a means for generating a synchronization sequence from at least one set of candidate sequences to represent a PCID for a candidate cell, where the at least one set of candidate sequences includes a first candidate sequence and a second candidate sequence, the first candidate sequence is configured in a reverse order of the second candidate sequence, and the PCID corresponding to the first candidate sequence is different than the PCID corresponding to the second candidate sequence; and transmitting the synchronization sequence.

Additionally, the NE 500 may be configured to or operable to support any one or combination of where the synchronization sequence is generated based at least in part on a parameter that specifies whether the first candidate sequence or the second candidate sequence is to be used to determine or represent the PCID, and where the parameter is transmitted in association with the synchronization sequence; the parameter specifies whether a forward sequence candidate or a reverse sequence candidate is to be used to determine or represent the PCID; the first candidate sequence is arranged in increasing order of frequency resources, and the second candidate sequence is arranged in decreasing order of frequency resources; the synchronization sequence and the at least one set of candidate sequences include PSS sequences; the synchronization sequence and the at least one set of candidate sequences include SSS sequences.

Additionally, or alternatively, the NE 500 may support at least one memory (e.g., the memory 504) and at least one processor (e.g., the processor 502) coupled with the at least one memory and configured to cause the NE to generate a synchronization sequence from at least one set of candidate sequences to represent a PCID for a candidate cell, where the at least one set of candidate sequences includes a first candidate sequence and a second candidate sequence, the first candidate sequence is configured in a reverse order of the second candidate sequence, and the PCID corresponding to the first candidate sequence is different than the PCID corresponding to the second candidate sequence; and transmit the synchronization sequence.

Additionally, the NE 500 may be configured to support any one or combination of where the synchronization sequence is generated based at least in part on a parameter that specifies whether the first candidate sequence or the second candidate sequence is to be used to determine or represent the PCID, and where the parameter is transmitted in association with the synchronization sequence; the parameter specifies whether a forward sequence candidate or a reverse sequence candidate is to be used to determine or represent the PCID; the first candidate sequence is arranged in increasing order of frequency resources, and the second candidate sequence is arranged in decreasing order of frequency resources; the synchronization sequence and the at least one set of candidate sequences include PSS sequences; the synchronization sequence and the at least one set of candidate sequences include SSS sequences.

For example, the processor 502 may support wireless communication at the NE 500 in accordance with examples as disclosed herein. The NE 500 may be configured to or operable to support a means for generating a synchronization sequence from at least one set of candidate sequences to represent a RAT for a candidate cell, where the at least one set of candidate sequences includes a first candidate sequence and a second candidate sequence, the first candidate sequence is configured in a reverse order of the second candidate sequence, and a first RAT represented by the first candidate sequence is different than a second RAT represented by the second candidate sequence; and transmitting the synchronization sequence.

Additionally, the NE 500 may be configured to or operable to support any one or combination of where the synchronization sequence is generated based at least in part on a parameter that specifies whether the first candidate sequence or the second candidate sequence is to be used to determine the RAT for the candidate cell; the parameter specifies whether a forward sequence candidate or a reverse sequence candidate is to be used to determine the RAT for the candidate cell.

Additionally, or alternatively, the NE 500 may support at least one memory (e.g., the memory 504) and at least one processor (e.g., the processor 502) coupled with the at least one memory and configured to cause the NE to generate a synchronization sequence from at least one set of candidate sequences to represent a RAT for a candidate cell, where the at least one set of candidate sequences includes a first candidate sequence and a second candidate sequence, the first candidate sequence is configured in a reverse order of the second candidate sequence, and a first RAT represented by the first candidate sequence is different than a second RAT represented by the second candidate sequence; and transmit the synchronization sequence.

Additionally, the NE 500 may be configured to support any one or combination of where the synchronization sequence is generated based at least in part on a parameter that specifies whether the first candidate sequence or the second candidate sequence is to be used to determine the RAT for the candidate cell; the parameter specifies whether a forward sequence candidate or a reverse sequence candidate is to be used to determine the RAT for the candidate cell.

The controller 506 may manage input and output signals for the NE 500. The controller 506 may also manage peripherals not integrated into the NE 500. In some implementations, the controller 506 may utilize an operating system such as iOS®, ANDROID®, WINDOWS®, or other operating systems. In some implementations, the controller 506 may be implemented as part of the processor 502.

In some implementations, the NE 500 may include at least one transceiver 508. In some other implementations, the NE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas to receive a signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

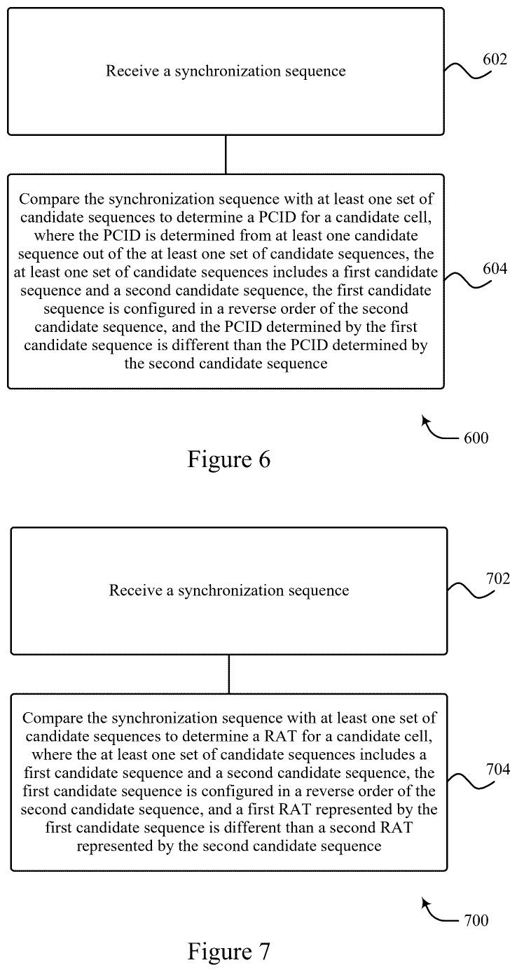

FIG. 6 illustrates a flowchart of a method 600 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 602, the method may include receiving a synchronization sequence. The operations of 602 may be performed in accordance with examples as described herein. In some implementations, aspects of the operations of 602 may be performed by a UE as described with reference to FIG. 3.

At 604, the method may include comparing the synchronization sequence with at least one set of candidate sequences to determine a PCID for a candidate cell, where the PCID is determined from at least one candidate sequence out of the at least one set of candidate sequences, the at least one set of candidate sequences includes a first candidate sequence and a second candidate sequence, the first candidate sequence is configured in a reverse order of the second candidate sequence, and the PCID determined by the first candidate sequence is different than the PCID determined by the second candidate sequence. The operations of 604 may be performed in accordance with examples as described herein. In some implementations, aspects of the operations of 604 may be performed by a UE as described with reference to FIG. 3.

FIG. 7 illustrates a flowchart of a method 700 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 702, the method may include receiving a synchronization sequence. The operations of 702 may be performed in accordance with examples as described herein. In some implementations, aspects of the operations of 702 may be performed by a UE as described with reference to FIG. 3.

At 704, the method may include comparing the synchronization sequence with at least one set of candidate sequences to determine a RAT for a candidate cell, where the at least one set of candidate sequences includes a first candidate sequence and a second candidate sequence, the first candidate sequence is configured in a reverse order of the second candidate sequence, and a first RAT represented by the first candidate sequence is different than a second RAT represented by the second candidate sequence. The operations of 704 may be performed in accordance with examples as described herein. In some implementations, aspects of the operations of 704 may be performed by a UE as described with reference to FIG. 3.

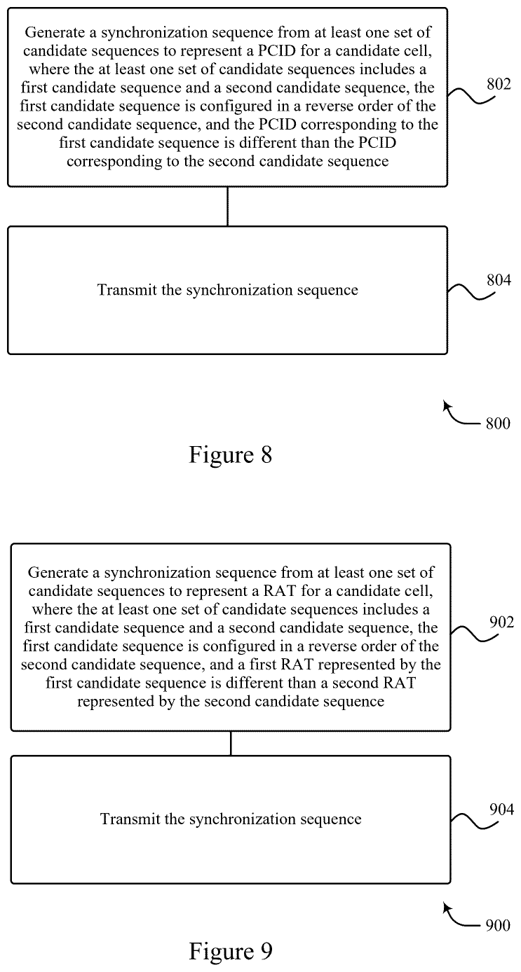

FIG. 8 illustrates a flowchart of a method 800 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 802, the method may include generating a synchronization sequence from at least one set of candidate sequences to represent a PCID for a candidate cell, where the at least one set of candidate sequences includes a first candidate sequence and a second candidate sequence, the first candidate sequence is configured in a reverse order of the second candidate sequence, and the PCID corresponding to the first candidate sequence is different than the PCID corresponding to the second candidate sequence. The operations of 802 may be performed in accordance with examples as described herein. In some implementations, aspects of the operations of 802 may be performed by an NE as described with reference to FIG. 5.

At 804, the method may include transmitting the synchronization sequence. The operations of 804 may be performed in accordance with examples as described herein. In some implementations, aspects of the operations of 804 may be performed by an NE as described with reference to FIG. 5.

FIG. 9 illustrates a flowchart of a method 900 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 902, the method may include generating a synchronization sequence from at least one set of candidate sequences to represent a RAT for a candidate cell, where the at least one set of candidate sequences includes a first candidate sequence and a second candidate sequence, the first candidate sequence is configured in a reverse order of the second candidate sequence, and a first RAT represented by the first candidate sequence is different than a second RAT represented by the second candidate sequence. The operations of 902 may be performed in accordance with examples as described herein. In some implementations, aspects of the operations of 902 may be performed by an NE as described with reference to FIG. 5.

At 904, the method may include transmitting the synchronization sequence. The operations of 904 may be performed in accordance with examples as described herein. In some implementations, aspects of the operations of 904 may be performed by an NE as described with reference to FIG. 5.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive a synchronization sequence; and
compare the synchronization sequence with at least one set of candidate sequences to determine a physical cell identifier (PCID) for a candidate cell, wherein the PCID is determined from at least one candidate sequence out of the at least one set of candidate sequences, the at least one set of candidate sequences comprises a first candidate sequence and a second candidate sequence, the first candidate sequence is configured in a reverse order of the second candidate sequence, and the PCID determined by the first candidate sequence is different than the PCID determined by the second candidate sequence.

2. The UE of claim 1, wherein comparison of the synchronization sequence is based at least in part on a parameter that specifies whether the first candidate sequence or the second candidate sequence is to be used to determine or represent the PCID.

3. The UE of claim 2, wherein the parameter specifies whether a forward sequence candidate or a reverse sequence candidate is to be used to determine or represent the PCID.

4. The UE of claim 1, wherein the first candidate sequence is arranged in increasing order of frequency resources, and the second candidate sequence is arranged in decreasing order of frequency resources.

5. The UE of claim 1, wherein the received synchronization sequence and the at least one set of candidate sequences comprise primary synchronization signal (PSS) sequences.

6. The UE of claim 1, wherein the received synchronization sequence and the at least one set of candidate sequences comprise secondary synchronization signal (SSS) sequences.

7. The UE of claim 1, wherein a cyclic shift is applied to the first candidate sequence or the second candidate sequence.

8. A network equipment (NE) for wireless communication, comprising:
at least one memory; and
at least one processor coupled with the at least one memory and operable to cause the NE to:
generate a synchronization sequence from at least one set of candidate sequences to represent a physical cell identifier (PCID) for a candidate cell, wherein the at least one set of candidate sequences comprises a first candidate sequence and a second candidate sequence, the first candidate sequence is configured in a reverse order of the second candidate sequence, and the PCID corresponding to the first candidate sequence is different than the PCID corresponding to the second candidate sequence; and
transmit the synchronization sequence.

9. The NE of claim 8, wherein the synchronization sequence is generated based at least in part on a parameter that specifies whether the first candidate sequence or the second candidate sequence is to be used to determine or represent the PCID, and wherein the parameter is transmitted in association with the synchronization sequence.

10. The NE of claim 9, wherein the parameter specifies whether a forward sequence candidate or a reverse sequence candidate is to be used to determine or represent the PCID.

11. The NE of claim 8, wherein the first candidate sequence is arranged in increasing order of frequency resources, and the second candidate sequence is arranged in decreasing order of frequency resources.

12. The NE of claim 8, wherein the synchronization sequence and the at least one set of candidate sequences comprise primary synchronization signal (PSS) sequences.

13. The NE of claim 8, wherein the synchronization sequence and the at least one set of candidate sequences comprise secondary synchronization signal (SSS) sequences.

14. A user equipment (UE) for wireless communication, comprising:
at least one memory; and
at least one processor coupled with the at least one memory and operable to cause the UE to:
receive a synchronization sequence; and
compare the synchronization sequence with at least one set of candidate sequences to determine a radio access technology (RAT) for a candidate cell, wherein the at least one set of candidate sequences comprises a first candidate sequence and a second candidate sequence, the first candidate sequence is configured in a reverse order of the second candidate sequence, and a first RAT represented by the first candidate sequence is different than a second RAT represented by the second candidate sequence.

15. The UE of claim 14, wherein comparison of the synchronization sequence is based at least in part on a parameter that specifies whether the first candidate sequence or the second candidate sequence is to be used to determine the RAT for the candidate cell.

16. The UE of claim 15, wherein the parameter specifies whether a forward sequence candidate or a reverse sequence candidate is to be used to determine the RAT for the candidate cell.

17. The UE of claim 14, wherein the received synchronization sequence and the at least one set of candidate sequences comprise one or more of primary synchronization signal (PSS) sequences or secondary synchronization signal (SSS) sequences.

18. A network equipment (NE) for wireless communication, comprising:
at least one memory; and
at least one processor coupled with the at least one memory and operable to cause the NE to:
generate a synchronization sequence from at least one set of candidate sequences to specify a radio access technology (RAT) for a candidate cell, wherein the at least one set of candidate sequences comprises a first candidate sequence and a second candidate sequence, the first candidate sequence is configured in a reverse order of the second candidate sequence, and a first RAT represented by the first candidate sequence is different than a second RAT represented by the second candidate sequence; and
transmit the synchronization sequence.

19. The NE of claim 18, wherein the synchronization sequence is generated based at least in part on a parameter that specifies whether the first candidate sequence or the second candidate sequence is to be used to determine the RAT for the candidate cell.

20. The NE of claim 19, wherein the parameter specifies whether a forward sequence candidate or a reverse sequence candidate is to be used to determine the RAT for the candidate cell.
